(19) United States
(12) Patent Application Publication
(10) Pub. No.: US 2003/0143979 A1
(43) Pub. Date: Jul. 31, 2003

(54) Information processing apparatus, URL providing apparatus, information processing system, and information processing method

(76) Inventors: Takahiko Suzuki, Ashiya-shi (JP); Yoshiteru Matsumura, Kadoma-shi (JP)

Correspondence Address: SHERIDAN ROSS PC, 1560 BROADWAY, SUITE 1200, DENVER, CO, 80202

(21) Appl. No.: 10/353,629

(22) Filed: Jan. 28, 2003

(30) Foreign Application Priority Data
Jan. 30, 2002 (JP) 2002-021291

(51) Int. Cl. H04M 11/00

(52) U.S. Cl. 455/406; 455/401

(57) ABSTRACT

An information processing apparatus of the present invention comprises an identifier input part for inputting an identifier of an individual, organization or apparatus; a URL list request information generating part for generating URL list request information including a request of URL list having a URL list and the identifier; a communicating part for transmitting the URL list request information to a URL list providing apparatus, receiving the URL list from the URL list providing apparatus, transmitting URL access information for access to a URL generated from a URL list processing part, and receiving information transmitted from the URL; and a URL list processing part for generating the URL access information on the basis of the received URL list, transmitting the URL access information to the communicating part, inputting information from the URL received by the communicating part, and generating and outputting an image signal or an audio signal on the basis of the information.

### BACKGROUND OF THE INVENTION

The present invention relates to an information processing apparatus, an information processing system, a URL providing apparatus, a URL list providing method, and an information processing method.

In these years, business by using Internet has become active. Advertising business via Internet has adopted the method by which users actively get access to the URLs with information on new products in which they become interested and obtain the information or the method by which advertising providers send information on products via e-mail.

A prior art URL display method will be described with reference to FIG. 9.

FIG. 9 is a block diagram showing an information processing system for getting access to URLs (Uniform Resource Locator) in a conventional example. The information processing apparatus of FIG. 9 has a display part 13, an information processing apparatus 92, an Internet 14, URLs 16 and 17, an ISP (Internet Service Provider) 18.

The information processing apparatus 92 has an input part 921, a URL access information generating part 922, a communicating part 923 and a URL information processing part 924.

The input part 921 is an input device such as a keyboard or a mouse, which designates a URL address requested by the user.

When a URL address to be accessed is inputted, the URL access information generating part 922 generates URL access information on the basis of an address of the information processing apparatus 92 and the URL address to be accessed and outputs the URL access information to the communicating part 923.

When inputting the URL access information, the communicating part 923 transmits the URL access information to the designated URL address on the Internet via the ISP 18, receives information transmitted from the URL (image, sound, etc.) and outputs the received information to the URL information processing part 924.

Based on the inputted information from the URL, the URL information processing part 924 generates an image signal or an audio signal and outputs it to the display part 13 (display, speaker, etc.).

As described above, the information processing system using Internet employs the method in which users actively select a URL address one by one.

Companies that provide products or services can make an attractive homepage (stored in a URL) and provide the user who gets access to the homepage with information on their products and so on via Internet. With prior art information processing systems (ex. Computers having an Internet access function), however, such companies cannot provide information on their products and so on unless the user actively gets access to a URL.

With the present invention, more effective use of Internet enables the information providing side to offer information actively.

For example, there is a strong likelihood that the user will look at information on new products with much interest, if information on new products selected on the basis of the user's own specific taste can be advertised on a display at the shop while the user who has purchased a product at a shop is waiting for the completion of procedures for credit card. In the case where the displayed information on new products relates to products dealt by the shop in which the display and the like is installed, the shop may increase sales.

By providing an optional combination of various image and audio information stored in URLs on display and so on, high level of product information can be offered at a low cost.

### SUMMARY OF THE INVENTION

In order to solve the above-mentioned problems, the present invention intends to provide an information processing apparatus, an information processing system and an information processing method capable of cheaply and properly providing users with information suited to their own hobbies, tastes and lifestyle, for example, when they do some shopping by using a cellular phone, credit card and so on.

The present invention further intends to provide an information processing apparatus, an information processing system and an information processing method that can cheaply and properly provide users with only information relating to products dealt by the shop at which they have done shopping.

For more effective advertising business and other businesses by Internet, the present invention intends to provide an information processing system and an information processing method that place an URL list providing apparatus on Internet, set a cellular phone number or credit card number of customers as their identifier, and make the URL list providing apparatus select to present URL according to the identifier to each customer.

The present invention provides an information processing system that enables the user to get access to any URL by cellular phone according to inputted advertising information and participate in a prize competition and the like.

An information processing apparatus according to the present invention from one aspect comprises a communicating part for receiving advertising information including Uniform Resource Locator (hereinafter referred to as “URL”) and information transmitted from a URL being accessed and for transmitting URL access information for access to a URL inputted or selected by the user; a display part for displaying the advertising information including the URLs and information from the URL being accessed; and an infrared data communicating part for transmitting the URLs included in the advertising information to a cellular phone and inputting an access command to the URL selected from the URLs included in the advertising information by users or an access command to the URL inputted by users from the cellular phone.

An information processing apparatus according to the present invention from another aspect comprises an identifier input part for inputting an identifier of an individual, organization or apparatus; a URL list request information generating part for generating a URL list request information including a request of a URL list having a URL list and the identifier; a communicating part for transmitting the URL list request information to a URL list providing apparatus, receiving the URL list from the URL list providing apparatus, transmitting URL access information for access to a URL generated by a URL list processing part, and receiving information transmitted from the URL; and the URL list processing part for generating the URL access information on the basis of the received URL list for transmitting to the communicating part, receiving information from the URL received by the communicating part, and generating and outputting an image signal or an audio signal on the basis of the information.

The above-mentioned information processing apparatus according to the present invention from another aspect is an information processing apparatus in which the URL list processing part outputs the image signal or the audio signal during a time period designated by the URL list, a predetermined time period, or a time period according to information amount, and then receives information from next URL in the URL list, and generates and outputs the image signal or the audio signal on the basis of the information.

The above-mentioned information processing apparatus according to the present invention from another aspect is an information processing apparatus in which the URL list processing part outputs the image signal by scrolling or page-feeding at a speed designated by the URL list or a constant speed.

The above-mentioned information processing apparatus according to the present invention from another aspect is an information processing apparatus in which the URL list request information generating part inputs keyword information and generates the URL list request information including the keyword information.

The above-mentioned information processing apparatus according to the present invention from another aspect is an information processing apparatus in which the URL list includes keyword information associated with each URL and the URL list processing part inputs keyword information, selects only URL associated with keyword information identical to or relating to the inputted keyword information in the URL list, generates the URL access information for access to the selected URL, and transmits the URL access information to the communicating part.

A URL list providing apparatus according to the present invention from another aspect comprises a communicating part for receiving URL list request information which includes a request of a URL list having a URL list and an identifier of an individual, organization or apparatus from an information processing apparatus and for transmitting the URL list to the information processing apparatus; a database storage part for storing the identifier and URL information, or the URL list associated with the identifier; and a URL list extracting part for generating the URL list associated with the inputted identifier from extracted URL information from the database storage part or selecting the URL list associated with the inputted identifier from the database storage part on the basis of the URL list request information, and then transmitting the generated or selected URL list to the communicating part.

The above-mentioned URL providing apparatus according to the present invention from another aspect is a URL providing apparatus in which the URL list request information further comprises keyword information; and the database storage part has URL information associated with the keyword information, the URL list associated with the identifier or the keyword information, or the URL list associated with the identifier having a URL associated with the keyword information; and the URL list extracting part generates the URL list associated with the inputted identifier and the inputted keyword information on the basis of URL information associated with the keyword information, or selects the URL list associated with the inputted identifier and the inputted keyword information, or generates new the URL list associated with the identifier and the keyword information by selecting only URL associated with the keyword information from the URL list associated with the inputted identifier, and then transmits the generated or selected URL list to the communicating part.

An information processing system according to the present invention from another aspect comprises the above-mentioned information processing apparatus and the above-mentioned URL list providing apparatus.

An information processing method according to the present invention from another aspect comprises an identifier input step of inputting an identifier of an individual, organization or apparatus; a URL list request information generating step of generating a URL list request information including a request of a URL list having a URL list and the identifier; a first transmitting step of transmitting the URL list request information to a URL list providing apparatus; a first receiving step of receiving the URL list from the URL list providing apparatus; a URL access information generating step of generating URL access information for access to a URL on the basis of the received URL list; a second transmitting step of transmitting the URL access information; a second receiving step of receiving information transmitted from the URL in accordance with the URL access information; and an information processing step of generating an image signal or an audio signal on the basis of the information received at the second receiving step and outputting the image signal or the audio signal.

The above-mentioned information processing method according to the present invention from another aspect is an information processing method that in the information processing step, the image signal or the audio signal are outputted during a time period designated by the URL list, a predetermined time period, or a time period according to information amount, and then information is received from a next URL in the URL list, and the image signal or the audio signal is generated and outputted on the basis of the information.

The above-mentioned information processing method according to the present invention from another aspect is an information processing method that in the information processing step, the image signal is outputted by scrolling or page-feeding at a speed designated by the URL list or a predetermined speed.

The above-mentioned information processing method according to the present invention from another aspect is information processing method that in the URL list request information generating step, keyword information is inputted and the URL list request information including the keyword information is generated.

The above-mentioned information processing method according to the present invention from another aspect is information processing method that the URL list includes keyword information associated with each URL and in the URL access information generating step, keyword information is input, only URL associated with keyword information identical to or relating to the inputted keyword information in the URL list is selected, and the URL access information for access to the selected URL is generated.

A URL list providing method according to the present invention from another aspect comprises: a receiving step of receiving a URL list request information including a request of a URL list having a URL list and an identifier of an individual, organization or apparatus; a URL list extracting step of generating or selecting the URL list associated with the inputted identifier on the basis of the URL list request information; and a transmitting step of transmitting the generated or selected URL list to the information processing apparatus.

The above-mentioned URL list providing method according to the present invention from another aspect is a URL list providing method that the URL list request information further comprises keyword information, and in the URL list extracting step, the URL list associated with the inputted identifier and keyword information is selected or generated.

The present invention can realize an information processing apparatus, an information processing system and an information processing method that are capable of providing users with URL information suited to their hobbies, tastes, lifestyle, and so on without necessitating active access by users.

The novel features of the invention are set forth with particularity in the appended claims. The invention as to both structure and content, and other objects and features thereof will best be understood from the detailed description when considered in connection with the accompanying drawings.

### BRIEF DESCRIPTION OF THE DRAWINGS

FIG. 1 is a block diagram of an information processing system in Embodiment 1.

FIG. 2 is an example of database.

FIG. 3 is an example of a URL list in the information processing system in Embodiment 1.

FIG. 4 is a flowchart of an information processing method using the information processing system in Embodiment 1.

FIG. 5 is a block diagram of an information processing system in Embodiments 2 and 3.

FIG. 6 is an example of a URL list in the information processing system in Embodiment 2.

FIG. 7 is a flowchart of an information processing method using the information processing system in Embodiment 2.

FIG. 8 is a flowchart of an information processing method using the information processing system in Embodiment 3.

FIG. 9 is a block diagram of an information processing system in a prior art example.

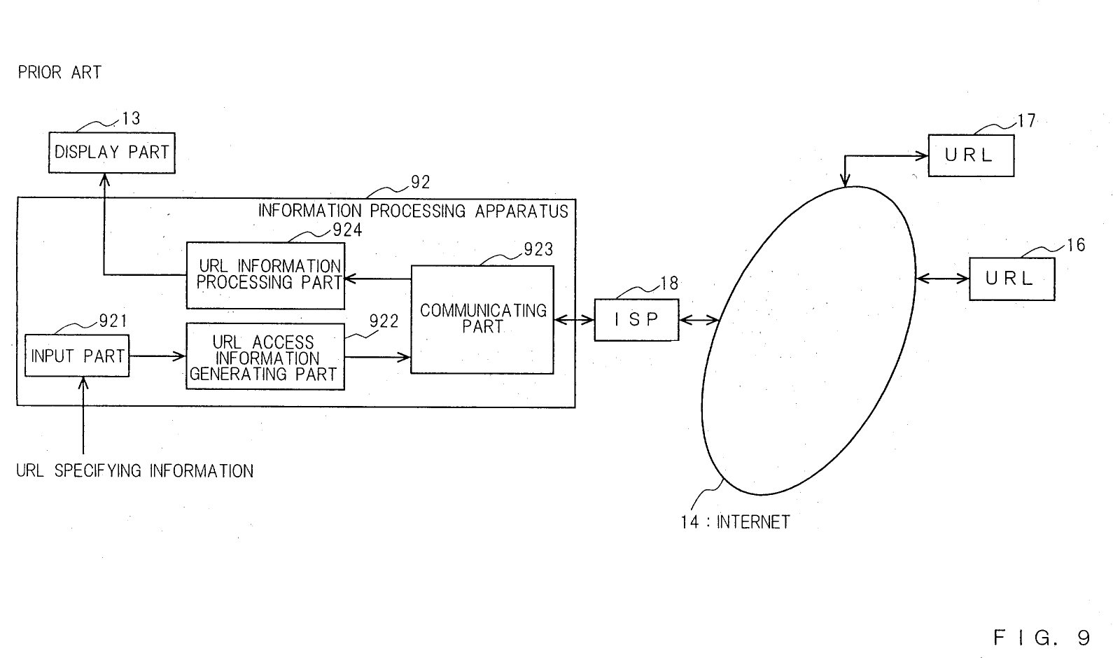

Part or all of the drawings are drawn schematically for diagrammatic representation and it should be considered that they do not necessarily reflect relative size and position of components shown therein.

### DETAILED DESCRIPTION OF THE INVENTION

Embodiments 1 to 3 as preferred embodiments of an information processing apparatus, a URL providing apparatus, an information processing system and an information processing method according to the present invention will be described below.

<<Embodiment 1>>

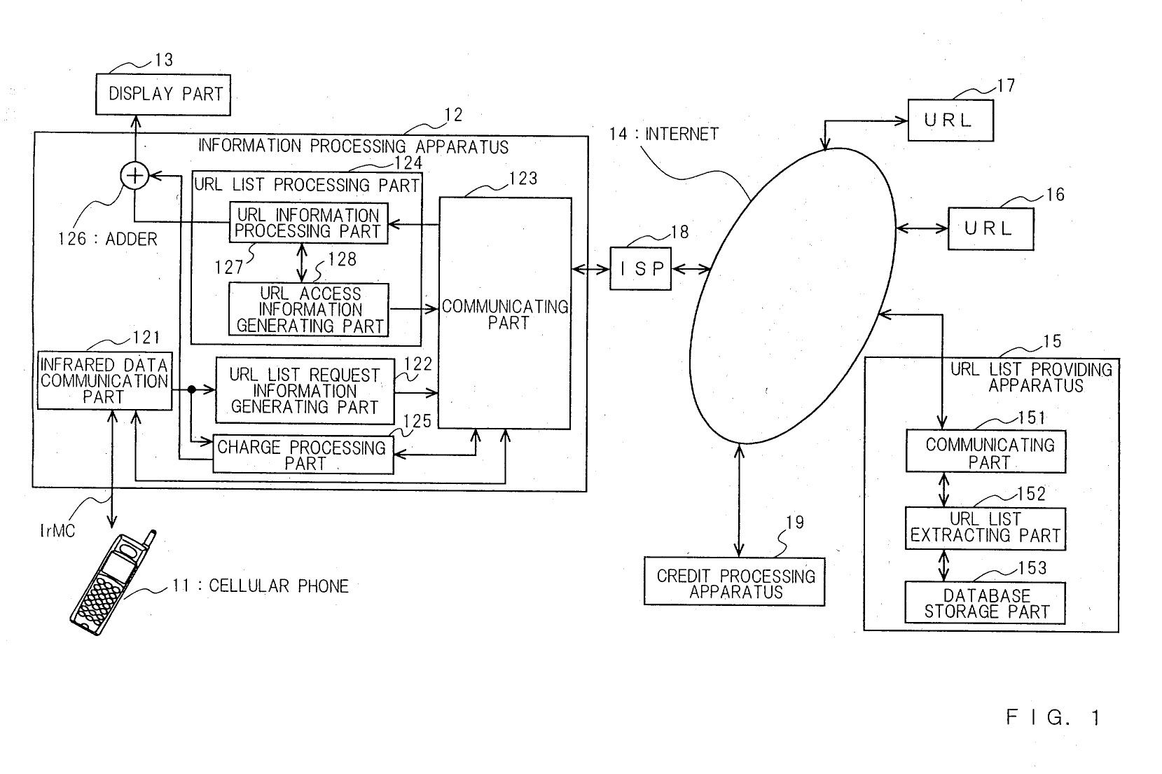

The information processing system and the information processing method in Embodiment 1 according to the present invention will be described with reference to FIGS. 1 to 4.

FIG. 1 is a block diagram showing the information processing system in Embodiment 1. The information processing system in this embodiment comprises a cellular phone 11, an information processing apparatus 12, a display part 13, an Internet 14, a URL list providing apparatus 15, URLs 16 and 17, an ISP 18 and a credit processing apparatus 19.

In general, multiple information processing apparatuses 12 are connected to the Internet 14, but only one information processing apparatus 12 is shown in FIG. 1.

The information processing apparatus 12 has an infrared data communicating part 121, a URL list request information generating part 122, a communicating part 123, a URL list processing part 124, a charge processing part 125 and an adder 126. The URL list processing part 124 has a URL Information processing part 127 and a URL access information generating part 128.

The URL list providing apparatus 15 has a communicating part 151, a URL list extracting part 152 and a data storage part 153.

The information processing apparatus 12 and the display part 13 (a liquid crystal display and a speaker in Embodiment 1) are placed at, for example, a self-feeding gas station. At the gas station, the user who feeds gasoline is supposed to pay charges by a credit card (not shown) or the cellular phone 11. The cellular phone 11 exchanges information with the information processing apparatus 12 on an infrared data communication system (IrMC (Infrared Mobile Communication) system in Embodiment 1). The cellular phone 11 has a phone number or other unique identifier, and pay charges by using the unique identifier on the same system as in credit card.

The information processing apparatus 12 will be explained below.

The infrared data communication part 121 inputs an identifier of an individual, organization or apparatus from the cellular phone 11 by infrared data communication, and transmits the identifier to the URL list request information generating part 122 and the charge processing part 125.

The URL list request information generating part 122 generates URL list (including a URL list) request information including the inputted identifier and requesting a URL list, and transmits it to the communicating part 123.

The communicating part 123 sends the inputted URL list request information to the URL list providing apparatus 15, receives a URL list from the URL list providing apparatus 15 and transmit to the URL list processing part 124.

The communicating part 123 inputs URL access information for getting access to URL generated by the URL list processing part 124, and gets access to the URL, and receives information sent from the URL, and transmits the information to the URL list processing part 124. Further, the communicating part 123 sends URL access information for getting access to URL inputted or selected by the user, and receives the information transmitted from the URL, and transmits the information to the URL list processing part 124. The communicating part 123 can also input advertising information including URL.

The communicating part 123 inputs an authentication request of user's the credit number or cellular phone number (identifier) outputted from the charge processing part 125, and transmits it the credit processing apparatus 19 through the ISP 18 and the Internet 14.

The communicating part 123 inputs the authentication result of the identifier (whether the identifier is valid or invalid) sent from the credit processing apparatus 19, and transmits the result to the charge processing part 125. Moreover, the communicating part 123 inputs charge of gasoline fed by the user from the charge processing part 125 and transmits it to the credit processing apparatus 19, as well as receives a response from the credit processing apparatus 19 and transmits it to the charge processing part 125.

Next, the URL list processing part 124 will be described below.

The URL access information generating part 128 generates URL access information for getting access to URL on the basis of the received URL list and transmits the information to the communicating part 123.

The URL information processing part 127 receives the information from URL received by the communicating part 123, generates an image signal or an audio signal on the basis of the information, and outputs it to the adder 126.

The URL information processing part 127 can also input information from URL inputted or selected by the user or advertising information including the URL received by the communicating part 123, generate an image signal or an audio signal on the basis of the information, and output it to the adder 126.

The adder 126 adds the image signal generated by the URL information processing part 127 to the image information (character and numerical representation of gasoline charge) generated by the charge processing part 125 to output. A liquid crystal display of the display part 13 represents the image signal and a speaker outputs the audio signal.

The charge processing part 125 inputs an identifier from the infrared data communication part 121, generates an authentication request of the identifier and transmits it to the communicating part 123, and then inputs the authentication result of the identifier transmitted from the credit processing apparatus 19 to the communicating part 123. In the case where the identifier is valid, the charge processing part 125 is set to be in the state that the user can feed gasoline. When the user feeds gasoline by self-service, the charge processing part 125 calculates the charge according to the feeding amount, generates an image signal for representing the charge in character and numeral, and transmits the signal to the adder 126. On completion of feeding, the charge processing part 125 transmits the charge to the communicating part 123. The charge processing part 125 receives a response corresponding to notification of the charge from the credit processing apparatus 19 and a receipt is printed.

The infrared data communication part 121 transmits URLs included in the advertising information received by the communicating part 123 to the cellular phone 11 by infrared data communication, and inputs an access instruction to URL selected by the user among URLs included in the advertising information or an access instruction to URL inputted by the user by means of cellular phone buttons, from the cellular phone 11. Alternatively, it is possible to get direct access to URLs 16 and 17 on Internet by cellular phone 11. For example, i-Mode (registered trademark) is used.

The URL list providing apparatus 15 will be described below.

The communicating part 151 receives URL list request information including an identifier of an individual, organization or apparatus and requiring a URL list from the information processing apparatus 12, and transmits it to the URL list extracting part 152. The communicating part 151 sends the URL list transmitted from the URL list extracting part 152 to the information processing apparatus 12.

The URL list extracting part 152 generates or selects the URL list associated with the identifier from the database storage part 153, and transmits the generated or selected URL list to the communicating part 151.

The database storage part 153 stores database of URL lists therein.

In Embodiment 1, the database storage part 153 has the URL lists associated with the user's identifier. The URL list providing apparatus 15 generates the URL list suited to hobbies, tastes and lifestyle according to information such as sex, age, occupation and hobby of the user, which is inputted from, for example, the credit processing apparatus 19, and stores the list in the database storage part 153. In Embodiment 1, the URL lists include the URL list with information and advertisement of products and services that have a great possibility to attract the user's attention.

Operations of the information processing system thus constituted will be described below.

The infrared data communication part 121 inputs a unique identifier of the cellular phone 11 or a unique identifier of owner (individual or company) of the cellular phone 11, recognize the identifier, and transmits the recognized identifier to the URL list request information generating part 122 and the charge processing part 125.

The URL list request information generating part 122 generates URL list request information requiring URL list associated with the identifier inputted from the infrared data communication part 121 and outputs the information to the communicating part 123.

When inputting the URL list request information, the communicating part 123 outputs the URL list request information to the communicating part 151 through the ISP 18 and the Internet 14.

When inputting the URL list request information, the communicating part 151 outputs the inputted URL list request information to the URL list extracting part 152.

The URL list extracting part 152 recognizes an identifier included in the inputted URL list request information, selects the URL list associated with the recognized identifier from the database storage part 153, and outputs the selected URL list to the communicating part 151.

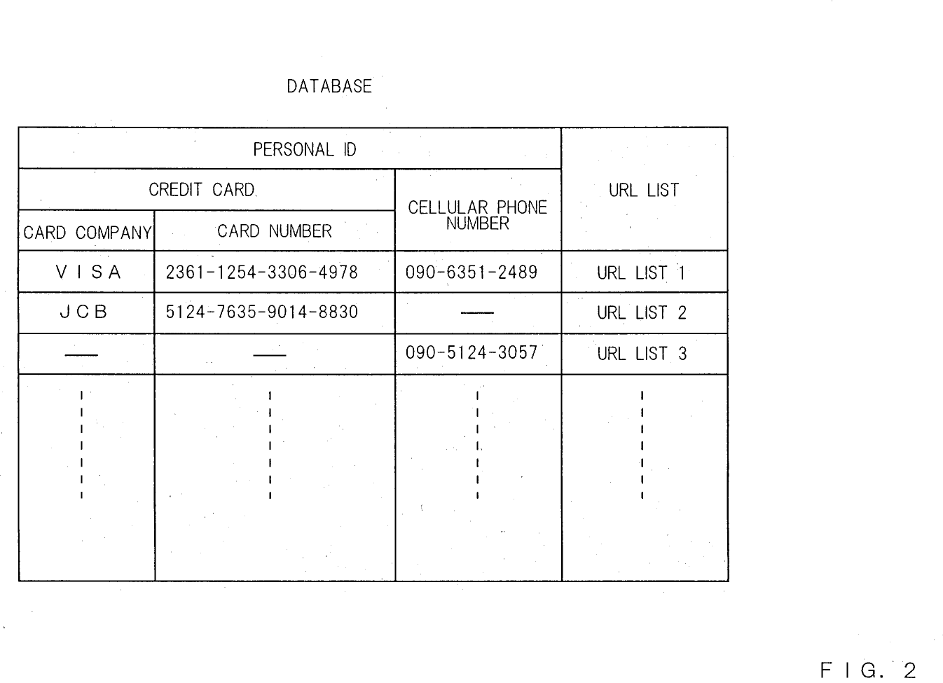

FIG. 2 shows an example of database stored in the database storage part 153.

Credit card number or cellular phone number is set as personal ID and a URL list for each personal ID is stored in the database.

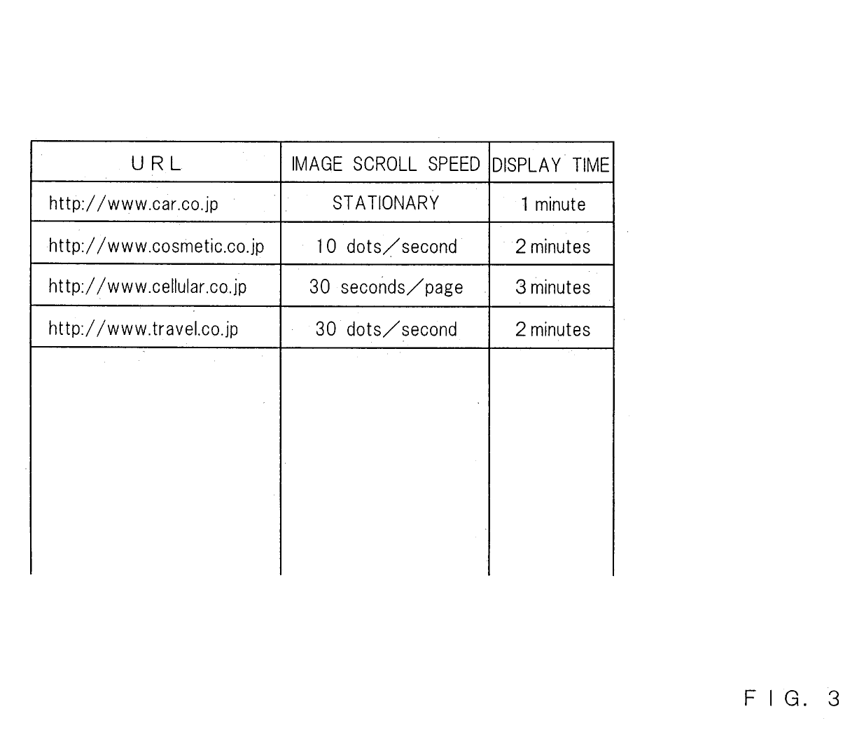

FIG. 3 shows an example of URL list. A URL list has plural URLs. URL address, image scroll rate and image display time that associated with each URL are stored.

The communicating part 151 inputs a URL list from the URL list extracting part 152 and outputs the inputted URL list to the communicating part 123 of the information processing apparatus 12 through the Internet 14 and the ISP 18.

The communicating part 123 outputs the URL list inputted from the URL list providing apparatus 15 to the URL access information generating part 128 of the URL list processing part 124.

When inputting the URL list, the URL access information generating part 128 generates URL access information (information for getting access to each URL) according to the URL list, and sends the information to URL through the communicating part 123 and the Internet 14.

The URL information processing part 127 obtains information transmitted from the URL, generates an image signal or an audio signal from the URL information and outputs the signal to the adder 126.

The adder 126 adds character representation of gasoline charge to the image signal generated by the URL information processing part 127 and outputs the result. The display part 13 outputs the image signal and the audio signal.

In outputting the image signal, the URL list processing part 124 scrolls it at the speed designated by the URL list (FIG. 3). Further, after the URL information processing part 127 outputs the image signal or the audio signal during the time period designated by the URL list (FIG. 3), the URL access information generating part 128 transmits URL access information to the next URL in the URL list. Then, the URL information processing part 127 receives information from the next URL, generates the image signal or the audio signal on the basis of the information, and outputs the signal.

The charge processing part 125 inputs an identifier of the cellular phone 11 and inquires of the credit processing apparatus 19 whether the identifier is valid or not. After then, when the identifier is valid, the charge processing part 125 allows the user to feed gasoline as well as generates an image signal for representing the gasoline charge in character and outputs the signal.

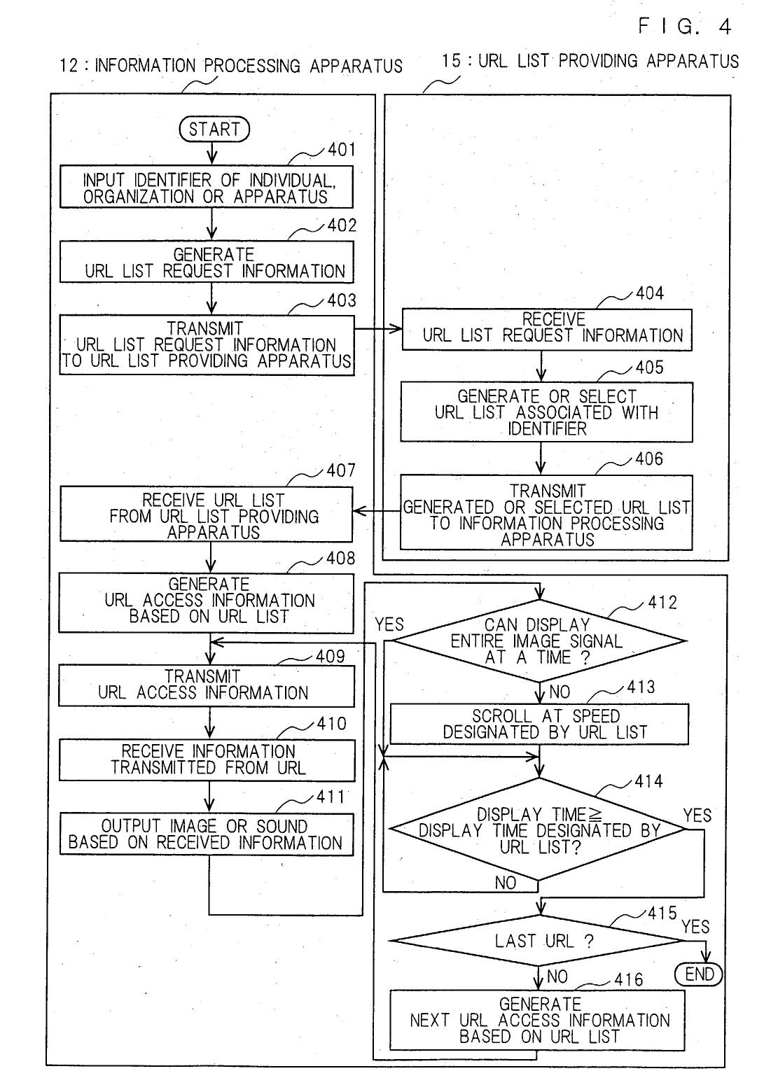

FIG. 4 shows a flowchart of the information processing method using the information processing apparatus according to the present invention. The information processing method using the information processing apparatus in Embodiment 1 has steps 401 to 416. Descriptions of processing performed in the charge processing part 125 and the credit processing apparatus 19 are omitted.

At first, the following steps are carried out in the information processing apparatus.

At the step 401, by using an device such as cellular phone, the user inputs an identifier of individual or apparatus into the information processing apparatus. At the step 402, URL list request information including the inputted identifier (requiring the URL list including a list of URL) is generated. At the step 403, the URL list request information generated in the previous step is transmitted to the URL list providing apparatus.

Next, the following steps are carried out in the URL list providing apparatus.

At the step 404, the URL list request information transmitted from the information processing apparatus is received. At the step 405, the URL list associated with the identifier included in the received URL list request information is generated or selected. At the step 406, the URL list generated or selected the step 405 is transmitted to the information processing apparatus.

The following steps are carried out in the information processing apparatus.

At the step 407, the URL list is received from the URL list providing apparatus.

At the step 408, URL access information for URL to be accessed is generated on the basis of the URL list received at the previous step. At the step 409, the URL access information generated at the previous step is transmitted. At the step 410, in accordance with the URL access information, information transmitted from the URL is received. At the step 411, an image or audio signal is outputted on the basis of the information received at the previous step. At the step 412, it is judged whether the entire image signal can be displayed at a time or not. At the step 412, in the case where it is judged that the entire image signal can be displayed at a time, the operation proceeds to the step 414. At the step 412, in the case where it is judged that the entire image signal cannot be displayed at a time, the image signal is displayed while being scrolled at the speed designated in the URL list (FIG. 3) at the step 413, and the operation proceeds to the step 414.

At the step 414, it is judged whether time during which the image signal is displayed has exceeded the display time designated in the URL list or not. In the case where it is judged that time during which the image signal is displayed has exceeded the display time designated in the URL list, the operation proceeds to the step 415. In the case where it is judged that time during which the image signal is displayed has not exceeded the display time designated in the URL list, the image signal continues to be displayed and after a certain time, decision at the step 414 is performed again. At the step 415, it is judged whether current URL on display is the last URL or not. In the case where it is the last URL, display of URL is finished. In the case of where it is not last URL, next URL access information is generated at the step 416 on the basis of the URL list, and the operation proceeds to the step 409 and the generated URL access information is transmitted to Internet.

In this embodiment, the user inputs an identifier of the cellular phone 11 of his/her own into the infrared data communication part 121, and usually look at the liquid crystal display of the display part 13 as well as listen to voice outputted from the speaker while waiting for authentication by the credit processing apparatus 19 and feeding gasoline. For example, while the user feeds gasoline watching the charge, information on products or services that may attract the user's attention is presented to the user. This allows the user to obtain useful information without actively seeking to get information stored in URLs by themselves. Manufactures of goods, sales companies and service providers can provide most suitable information and advertisement of their products for the user by grasping the opportunity to input user's identifier.

In the present embodiment, it may be constituted so that the information processing apparatus can be operated with touch-panel control, and accordingly, when the customer finds any interesting product in advertisement, he/she can easily access detailed information on the product. Moreover, the customer can obtain more detailed information or participate in a prize competition via Internet. Representation of advertisement on the display of the cellular phone (such as advertisement based on hyperlink display of URL) enables easier entry, thereby achieving integration of advertisement and entry acceptance.

In Embodiment 1, the database storage part 153 of the URL list providing apparatus 15 stores URL lists by each identifier therein. In other embodiments, however, the database storage part 153 stores identifiers and the corresponding characteristics (ex. sex, age, occupation, family structure, income, hobby and product purchase history of the user having an identifier), as well as URLs and the characteristics of URLs (targeted for male or female, etc.). When inputting an identifier, the URL list extracting part 152 generates the URL list suited to the identifier on the basis of the information stored in the database storage part 153 and transmits it the communicating part 151.

In Embodiment 1, in the case where the image obtained from the URL does not fall within display area of the liquid crystal display (the display part 13), the URL information processing part 127 scrolls the image at the speed designated by the URL list (FIG. 3). Page-feeding in substitution for scrolling may be performed. Furthermore, in Embodiment 1, the URL information processing part 127 scrolls the image at the speed designated in the URL list and displays the image for the time period designated in the URL list, and after that, the URL access information generating part 128 gets access to the next URL. In the other embodiments, however, the URL information processing part 127 scrolls the image at the speed designated in the information processing apparatus and displays the image signal for the time period designated in the information processing apparatus, and after that, the URL access information generating part 128 gets access to the next URL.

As an example of a method for making the URL list in this embodiment, credit card companies make a URL list based on the user's preference according to the user's information obtained at the registration of credit card (for example, obtain information by questionnaires at the registration) or mobile phone service providers make a URL list based on the user's preference according to the user's information obtained at the registration of cellular phone. When the user actively gets access to the URL of product information from the cellular phone 11, the information processing apparatus 12 transmits the identifier of the cellular phone 11 and the URL accessed this time to the URL list providing apparatus 15. The URL list providing apparatus 15 additionally registers the accessed URL in the URL list associated with the identifier of the cellular phone 11.

<<Embodiment 2>>

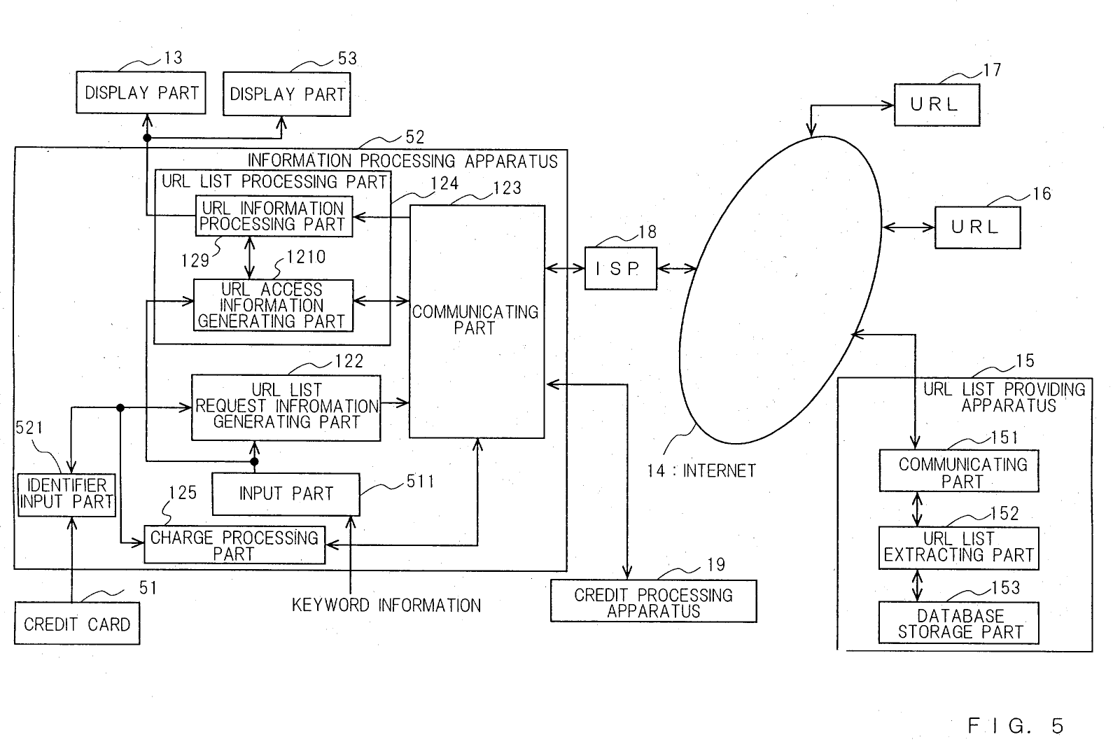

The information processing system and the information processing method in Embodiment 2 according to the present invention will be described with reference to FIGS. 5 to 7.

FIG. 5 shows a block diagram of the information processing system in Embodiment 2. The information processing system in this embodiment comprises a credit card 51, an information processing apparatus 52, display parts 13 and 53, the Internet 14, the URL list providing apparatus 15, URLs 16 and 17, the ISP 18 and the credit processing apparatus 19.

The information processing apparatus 52 has an identifier input part 521, the URL list request information generating part 122, the communicating part 123, the URL list processing part 124, the charge processing part 125 and input part 511.

The URL list processing part 124 has a URL information processing part 129 and a URL access information generating part 1210. The URL list providing apparatus 15 has the communicating part 151, the URL list extracting part 152 and the database storage part 153.

The display parts 53 and 13 carry out the same function.

The input part 511 outputs keyword information inputted by the user to the URL list request information generating part 122.

The credit processing apparatus 19 performs processing for automatic debit from the user's bank account when the user has done shopping by the credit card 51.

The information processing apparatus 52 and the display parts 13 and 53 (a liquid crystal display and a speaker in Embodiment 2) are placed in, for example, cosmetic stores. In the cosmetic stores, the user is supposed to pay by using the credit card 51 or a cellular phone (not shown).

In FIG. 5, the same reference numerals as in FIG. 1 (Embodiment 1) are assigned to the blocks having the corresponding functions, and detailed descriptions thereof are omitted for simplicity. In the block diagram of this embodiment, however, the URL list request information generating part 122 generates request of the URL list including the identifier and keyword information inputted from the input part 511. Further, the URL list extracting part 152 in this embodiment is different from that in Embodiment 1 in that it generates or selects the URL list including the identifier and keyword information.

Operations of the information processing apparatus thus constructed will be described below.

When the user uses the credit card 51, cosmetic stores, for example, inputs keyword information on desired information (such as a keyword “cosmetics”). The information processing apparatus 52 communicates with the credit processing apparatus 19 via the communicating part 123 and performs processing for automatic debit from the user's bank account for the purchase. The identifier input part 521 inputs the credit card number, recognizes the number as an identifier, and outputs the recognized identifier to the URL list request information generating part 122 and the charge processing part 125.

The URL list request information generating part 122 generates URL list request information requiring the URL list associated with the inputted identifier and the inputted keyword information, and outputs it to the communicating part 123.

When inputting the URL list request information, the communicating part 123 outputs the inputted URL list request information to the communication part 151 of the URL list providing apparatus 15.

When inputting the URL list request information, the communicating part 151 outputs the inputted URL list request information to the URL list extracting part 152.

The URL list extracting part 152 generates or selects the URL list associated with the identifier and keyword information included in the inputted URL list request information from the database storage part 153, and outputs the generated or selected URL list to the communicating part 151.

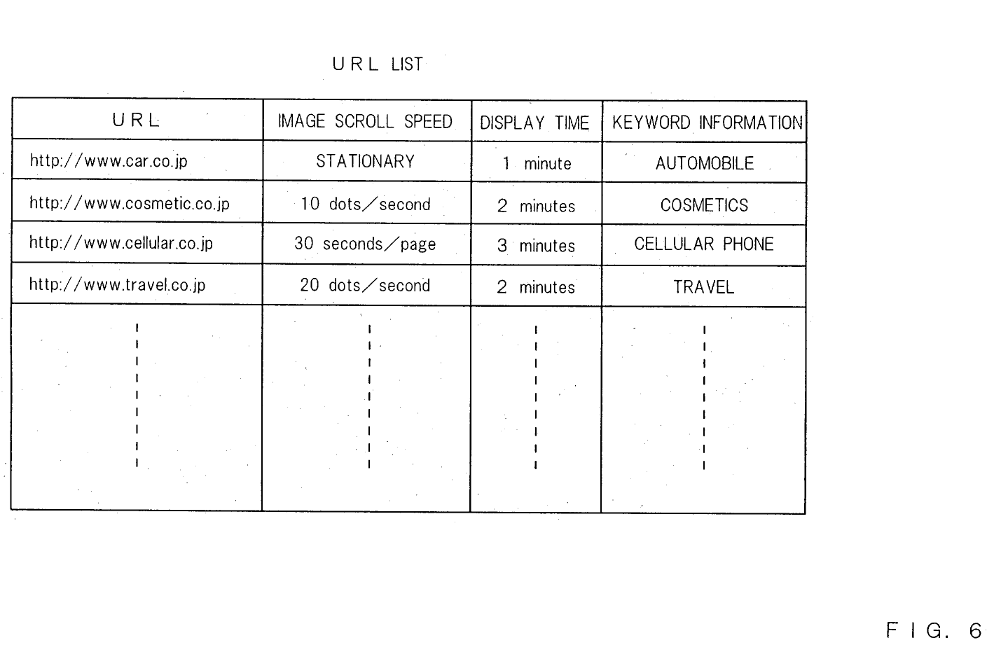

FIG. 6 shows an example of the URL list in this embodiment. The URL list in this embodiment includes keyword information in addition to the contents in the URL list in Embodiment 1 (FIG. 3). The URL list extracting part 152 extracts only URLs having keyword information that is identical or relevant to the inputted keyword information “cosmetics”,and generates a new URL list and transmits it to the communicating part 151.

The communicating part 151 inputs the URL list from the URL list extracting part 152 and outputs the inputted URL list to the communicating part 123 of the information processing apparatus 52 through the Internet 14 and the ISP 18.

The communicating part 123 outputs the URL list inputted from the URL list providing apparatus 15 to the URL access information generating part 1210 of the URL list processing part 124.

When inputting the URL list, the URL access information generating part 1210 generates URL access information in accordance with the inputted URL list, and transmits it to the URL through the communicating part 123 and the Internet 14.

The URL information processing part 129 obtains the information sent from the URL, generates an image signal or an audio signal from the URL information, and outputs the signal to the display parts 13 and 53.

The URL information processing part 129 can also display a distinct image signal obtained from distinct URL on plural display parts 13 and 53, respectively.

Operations between the credit card 51, the charge processing part 125, and the credit processing apparatus 19 are similar to those in Embodiment 1.

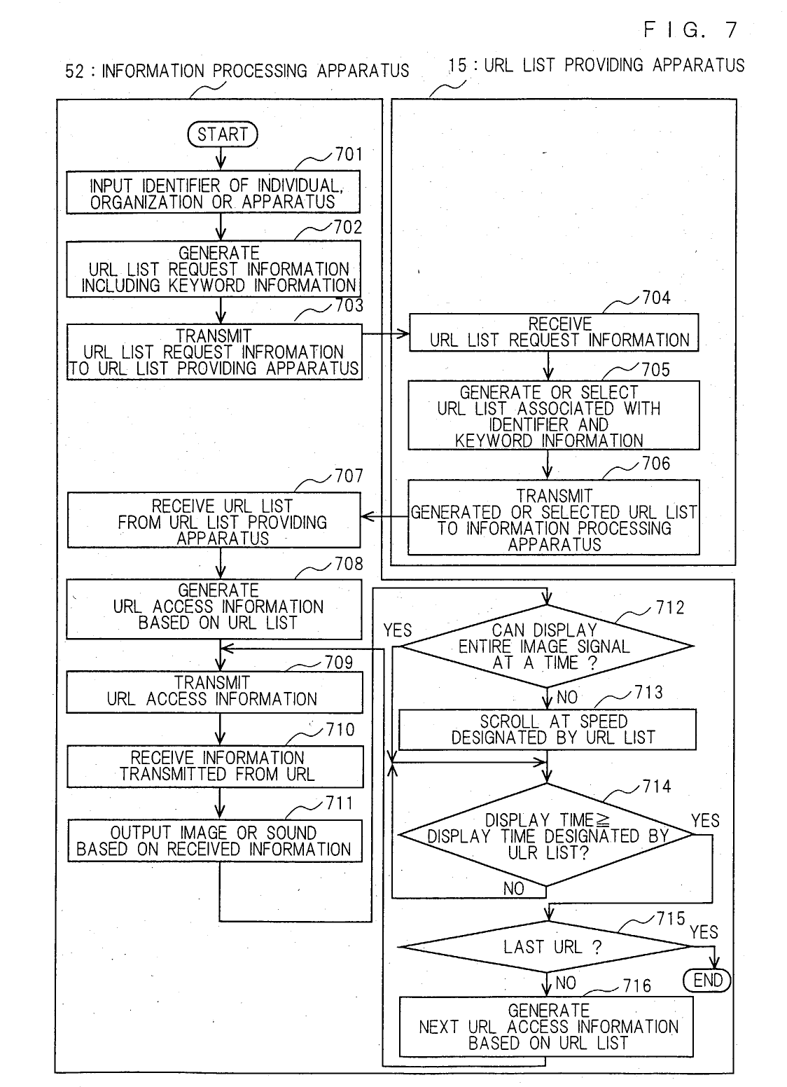

FIG. 7 shows a flowchart of the information processing method using the information processing apparatus in Embodiment 2. The information processing method using the information processing apparatus in Embodiment 2 has steps 701 to 716. Descriptions of processing performed between the charge processing part 125 and the credit processing apparatus 19 will be omitted.

Initial steps are carried out in the information processing apparatus 52.

At the step 701, the user inputs an identifier of individual or apparatus by using a device such as a credit card. At the step 702, the store inputs keyword information relating to the information that it wants to present to the user. Alternatively, the user itself may input keyword information relating to the information of interest. URL list request information including this keyword information and the identifier inputted at the previous step is generated. At the step 703, the URL list request information generated at the previous step is transmitted to the URL list providing apparatus 15.

The following steps are carried out in the URL list providing apparatus 15.

At the step 704, the URL list request information transmitted from the information processing apparatus 52. At the step 705, the URL list associated with the identifier and the keyword information included in the received URL list request information is generated or selected. In Embodiment 2, the URL list is a new URL list generated by extracting only URLs with keyword information that is identical or relevant to the inputted keyword information from the URL list stored in the database storage part 153 and corresponds to the identifier. At the step 706, the URL list generated at the previous step is transmitted to the information processing apparatus 52.

The following steps are carried out in the information processing apparatus 52.

At the step 707, the URL list is received from the URL list providing apparatus 15. At the step 708, on the basis of the URL list received at the previous step, access information of URL to be accessed is generated. At the step 709, the URL access information generated at the previous step is transmitted. At the step 710, according to the URL access information, the information transmitted from the URL is received. At the step 711, on the basis of the information received at the previous step, an image signal or an audio signal is outputted. At the step 712, it is judged whether the entire image signal can be displayed on the display part 13 at a time or not. At the step 712, in the case where it is judged that the entire image signal can be displayed at a time, operation proceeds to the step 714. At the step 712, in the case where it is judged that the entire image signal cannot be displayed at a time, the image signal is displayed while being scrolled at the speed designated in the URL list at the step 713, and the operation proceeds to the step 714. At the step 714, it is judged whether time during which the image signal is displayed has exceeded the display time designated in the URL list or not. In the case where it is judged that time during which the image signal is displayed has exceeded the display time designated in the URL list, the operation proceeds to the step 715. In the case where it is judged that time during which the image signal is displayed has not exceeded the display time designated in the URL list, the image continues to be displayed and after a certain time, decision at the step 714 is performed again. At the step 715, it is judged whether current URL on display is the last URL or not. In the case where it is the last URL, display of URL is finished. In the case of where it is not last URL, next URL access information is generated at the step 716 on the basis of the URL list, and the operation proceeds to the step 709 and the generated URL access information is transmitted to the Internet.

In Embodiment 2, when the user has purchased a product at, for example, a cosmetic store by credit card, it is possible to provide the user with products information suited to his/her preference and so on until settlement processing of credit card between the information processing apparatus and the credit processing apparatus is finished. For example, by inputting the keyword information “cosmetics” (which can be registered), the cosmetic store can provide the user with only information on cosmetics related to its cosmetic business. That is, the cosmetic store can eliminate information irrelevant to its cosmetic business, for example, car information, and make good use of the valuable opportunity to provide the user with information. Alternatively, it is possible that the user selects a certain manufacturer of cosmetics as keyword information by means of touch-panel and the like, thereby to display only products of the selected manufacturer.

Further, the URLs included in advertising information inputted from the communicating part 123 can be transmitted to the cellular phone by infrared data communication. Access instruction to the URL selected from the URLs included in the advertising information by the user or access instruction to the URL inputted from the user by the manipulation of the cellular phone buttons is transmitted from the cellular phone to the information processing apparatus. The information processing apparatus gets access to the URL and obtains information. The user may directly get access to the URLs 16 and 17 on Internet with the cellular phone and obtain information from the URLs.

In Embodiment 2, the database storage part 153 has the URL list associated with the identifier, and each URL included in the URL list is associated with keyword information (FIG. 6).

In another embodiment, the database storage part 153 has URL lists associated with the identifier and the keyword information. On the basis of the inputted identifier and the inputted keyword information, the URL list extracting part 152 selects the URL list associated with the same identifier and the identical or similar keyword information, and transmits the URL list to the communicating part 151.

Further, in another embodiment, the database storage part 153 stores the identifier and the characteristics corresponding to the identifier (such as hobby of the user with identifier), as well as the URL, the characteristics corresponding to the URL and keyword information representing the characteristics. On the basis of the inputted identifier and inputted keyword information, the URL list extracting part 152 generates the URL list associated with the same identifier and the identical or similar keyword information, and transmits the URL list to the communicating part 151.

Further, in another embodiment, the database storage part 153 stores the URL list associated with only keyword information, not identifier, therein. The URL list extracting part 152 generates the URL list associated with the keyword information that is identical or relevant to the keyword information included in the URL list request information, and suited to the user's identifier.

As an example of the method for making the database in this embodiment, when the user has done shopping with credit card, the information processing apparatus 12 transmits the credit card's identifier and keyword information of this shopping to the URL list providing apparatus 15. The URL list providing apparatus 15 selects the URL related to the keyword information of the shopping and adds the selected URL to the URL list associated with the credit card's identifier.

Further, as another example of the method for making the database, the URL list providing apparatus can select the URL related to business of the store or organization in which the information processing apparatus 12 is placed, and add the selected URL to the URL list.

<<Embodiment 3>>

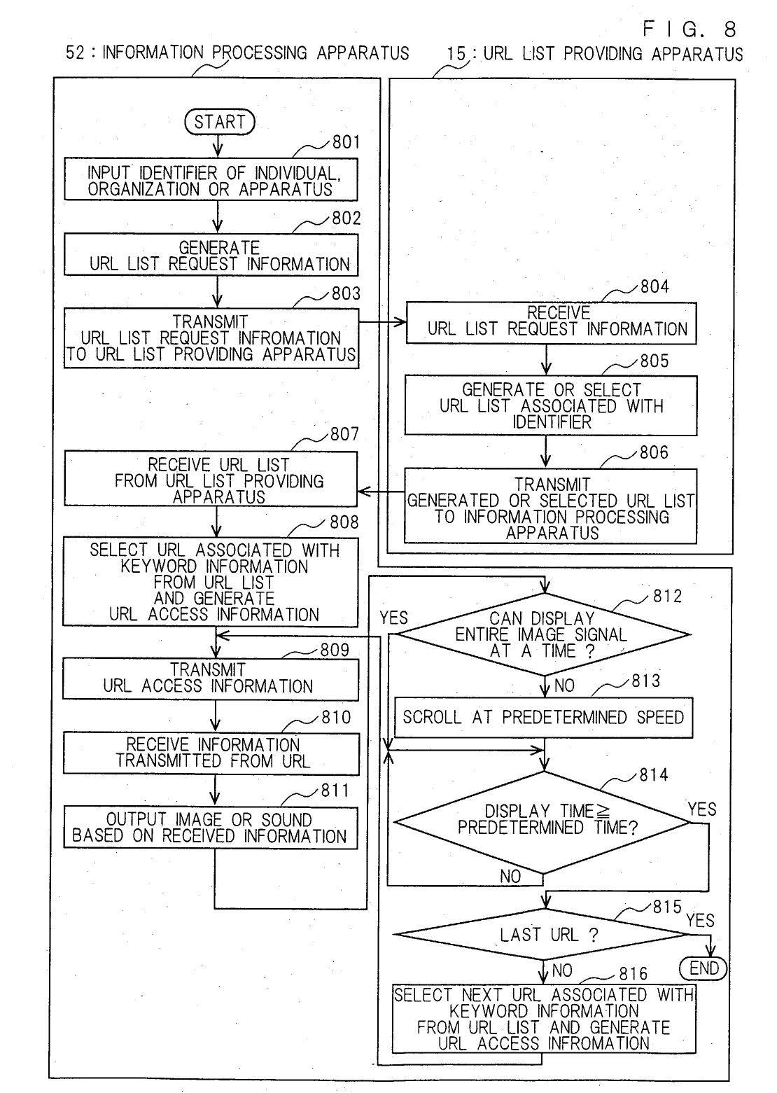

An information processing apparatus and an information processing method in Embodiment 3 will be described with reference to FIGS. 5 and 8. An information processing system in Embodiment 3 has the same constitution as that in Embodiment 2 (FIG. 5).

In the information processing system in Embodiment 3, the input part 511 outputs keyword information to the URL access information generating part 1210 of the URL list processing part 124, not to the URL list request information generating part 122. The URL list request information generating part 122 generates and outputs the URL list request information including no keyword information. The URL list extracting part 152 generates or selects the URL list (including URL associated with various keywords) on the basis of only identifier, and transmits the URL list to the URL access information generating part 1210 of the URL list processing part 124 through the communicating part 151, the ISP 18 and the communicating part 123. The URL access information generating part 1210 selects the URL that includes the keyword information inputted from the input part 511 (such as “cosmetics”)from the inputted URL list, and in order to get access the selected URL, generates and outputs URL access information. The URL information processing part 129 obtains URL information from Internet through the communicating part 123 and the ISP 18.

The information processing system in Embodiment 3 is different from that in Embodiment 2 in the above-mentioned points. Both of the information processing systems are identical to each other in other points.

FIG. 8 shows a flowchart of the information processing method using the information processing system according to Embodiment 3. The information processing method as shown in FIG. 8 has steps 801 to 816.

Initial steps are carried out in the information processing apparatus.

At the step 801, the user inputs the identifier of an individual or apparatus by using a device such as a credit card. At the step 802, URL list request information including the identifier inputted at the previous step is generated. At the step 803, the URL list request information generated at the previous step is transmitted to the URL list providing apparatus.

The following steps are carried out in the URL list providing apparatus.

At the step 804, the URL list request information transmitted from the information providing apparatus is received. At the step 805, the URL list (including keyword information) associated with the identifier included in the received URL list request information is generated or selected. At the step 806, the URL list generated or selected at the previous step is transmitted to the information processing apparatus.

The following steps are carried out in the information processing apparatus.

At the step 807, the URL list is received from the URL list providing apparatus 15. At the step 808, the store or the user inputs keyword information of the information in which it becomes interested. The URL associated with the keyword information is selected from the URL list received at the previous step, and access information of the URL to be accessed is generated. At the step 809, the URL access information generated at the previous step is transmitted. At the step 810, according to the URL access information, the information transmitted from the URL is received. At the step 811, on the basis of the information received at the previous step, an image signal or an audio signal is outputted. At the step 812, it is judged whether the entire image signal can be displayed at a time or not. At the step 812, in the case where it is judged that the entire image signal can be displayed at a time, operation proceeds to the step 814. At the step 812, in the case where it is judged that the entire image signal cannot be displayed at a time, the image signal is displayed while being scrolled at a constant speed at the step 813, and the operation proceeds to the step 814. At the step 814, it is judged whether time during which the URL is displayed has exceeded the predetermined time or not. In the case where it is judged that time during which the image signal is displayed has exceeded the predetermined time, operation proceeds to the step 815. In the case where it is judged that time during which the image signal is displayed has not exceeded the predetermined time, the URL continues to be displayed and after a certain time, decision at the step 814 is performed again. At the step 815, it is judged whether current URL on display is the last URL or not. In the case where it is the last URL, display of URL is finished. In the case of where it is not last URL, at the step 816, next URL associated with the keyword information is selected from the URL list, and URL access information is generated. And then, the operation proceeds to the step 809 and the generated URL access information is transmitted to the Internet.

The information processing system in Embodiment 3 has similar effects to that in Embodiment 2.

According to the present invention, it is possible to provide the URL list providing apparatus on the Internet, generate the URL list from the identifier of cellular phone, credit card and so on, and offer information suited to the user's preference.

According to the present invention, it is also possible to obtain the advantageous effect of achieving the information processing apparatus, the information processing system and the information processing method that present URL information suited to the user's hobby and the like without necessity of the user's active access.

Moreover, in the case where the user has purchased some product or received some service by using a credit card, cellular phone or the like, information on the purchased product or the received service can be collected as personal data. Since this enables detailed information on the basis of the user's preference to be obtained, it is also possible to provide the URL list that are more suitable for the user's preference.

In contrast to the method of directly providing the user with information on the basis of the user's identifier, the URL list providing apparatus only transmits the URL list, and therefore the amount of information to be processed is small. By sending the URL list to each information processing apparatus, the URL list providing apparatus distributes burdens of processing to the information processing apparatuses and makes them to take charge of a part of processing of obtaining information from URL.

The small-sized cheap URL list providing apparatus allows the user to receive high quality of information (such as information on products). Each information processing apparatus obtains URL information automatically according to the URL list and displays the information, thereby that the user can get various information without actively manipulating the apparatus. In the case where the obtained information is a large image signal, the user can read all information included therein by scrolling the image at a predetermined speed.

According to the present information, it is possible to realize the information processing apparatus that the user can get access to an optional URL with the cellular phone and participate in a prize competition, on the basis of the inputted advertising information.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

1. An information processing apparatus comprising:
a communicating part for receiving advertising information including Uniform Resource Locator (hereinafter referred to as “URL”) and information transmitted from a URL being accessed and for transmitting URL access information for access to a URL inputted or selected by users;
a display part for displaying said advertising information including URLs and information from said URL being accessed; and
an infrared data communicating part for transmitting said URLs included in said advertising information to a cellular phone and for inputting an access command to said URL selected from said URLs included in said advertising information by users or an access command to said URL inputted by users from said cellular phone.

2. An information processing apparatus comprising:
an identifier input part for inputting an identifier of an individual, organization or apparatus;
a URL list request information generating part for generating a URL list request information including a request of a URL list having a URL list and said identifier;
a communicating part for transmitting said URL list request information to a URL list providing apparatus, receiving said URL list from said URL list providing apparatus, transmitting URL access information for access to a URL generated by a URL list processing part, and receiving information transmitted from said URL; and
said URL list processing part for generating said URL access information on the basis of said received URL list for transmitting to said communicating part, receiving information from said URL received by said communicating part, and generating and outputting an image signal or an audio signal on the basis of said information.

3. An information processing apparatus in accordance with claim 2, wherein said URL list processing part outputs said image signal or said audio signal during a time period designated by said URL list, a predetermined time period, or a time period according to information amount, and then receives information from next URL in said URL list, and generates and outputs said image signal or said audio signal on the basis of said information.

4. An information processing apparatus in accordance with claim 2, wherein said URL list processing part outputs said image signal by scrolling or page-feeding at a speed designated by said URL list or a constant speed.

5. An information processing apparatus in accordance with claim 2, wherein said URL list request information generating part inputs keyword information and generates said URL list request information including said keyword information.

6. An information processing apparatus in accordance with claim 2, wherein said URL list includes keyword information associated with each URL; and said URL list processing part inputs keyword information, selects only URL associated with keyword information identical to or relating to said inputted keyword information in said URL list, generates said URL access information for access to said selected URL, and transmits said URL access information to said communicating part.

7. A URL list providing apparatus comprising:
a communicating part for receiving URL list request information which includes a request of a URL list having a URL list and an identifier of an individual, organization or apparatus from an information processing apparatus and for transmitting said URL list to said information processing apparatus;
a database storage part for storing said identifier and URL information, or said URL list associated with said identifier; and
a URL list extracting part for generating said URL list associated with said inputted identifier from extracted URL information from said database storage part or selecting said URL list associated with said inputted identifier from said database storage part on the basis of said URL list request information, and then transmitting said generated or selected URL list to said communicating part.

8. A URL providing apparatus in accordance with claim 7, wherein said URL list request information further comprises keyword information;
said database storage part has URL information associated with said keyword information, said URL list associated with said identifier and said keyword information, or said URL list associated with said identifier having URL associated with said keyword information; and
said URL list extracting part generates said URL list associated with said inputted identifier and said inputted keyword information on the basis of URL information associated with said keyword information, or selects said URL list associated with said inputted identifier and said inputted keyword information, or generates new said URL list associated with said identifier and said keyword information by selecting only URL associated with said keyword information from said URL list associated with said inputted identifier, and then transmits said generated or selected URL list to said communicating part.

9. An information processing system comprising an information processing apparatus in accordance with claim 2 and a URL list providing apparatus in accordance with claim 7.

10. An information processing method comprising:
an identifier input step of inputting an identifier of an individual, organization or apparatus;
a URL list request information generating step of generating a URL list request information including a request of a URL list having a URL list and said identifier;
a first transmitting step of transmitting said URL list request information to a URL list providing apparatus;
a first receiving step of receiving said URL list from said URL list providing apparatus;
a URL access information generating step of generating URL access information for access to a URL on the basis of said received URL list;
a second transmitting step of transmitting said URL access information;
a second receiving step of receiving information transmitted from said URL in accordance with said URL access information; and
an information processing step of generating an image signal or an audio signal on the basis of said information received at said second receiving step and outputting said image signal or said audio signal.

11. An information processing method in accordance with claim 10, wherein in said information processing step, said image signal or said audio signal are outputted during a time period designated by said URL list, a predetermined time period, or a time period according to information amount, and then information is received from a next URL in said URL list, and said image signal or said audio signal is generated and outputted on the basis of said information.

12. An information processing method in accordance with claim 10, wherein in said information processing step, said image signal is outputted by scrolling or page-feeding at a speed designated by said URL list or a predetermined speed.

13. An information processing method in accordance with claim 10, wherein in said URL list request information generating step, keyword information is inputted and said URL list request information including said keyword information is generated.

14. An information processing method in accordance with claim 10, wherein said URL list includes keyword information associated with each URL; and in said URL access information generating step, keyword information is input, only URL associated with keyword information identical to or relating to said inputted keyword information in said URL list is selected, and said URL access information for access to said selected URL is generated.

15. A URL list providing method comprising:
a receiving step of receiving a URL list request information including a request of a URL list having a URL list and an identifier of an individual, organization or apparatus;
a URL list extracting step of generating or selecting said URL list associated with said inputted identifier on the basis of said URL list request information; and
a transmitting step of transmitting said generated or selected URL list to said information processing apparatus.

16. A URL list providing method in accordance with claim 15, wherein said URL list request information further comprises keyword information; and
in said URL list extracting step, said URL list associated with said inputted identifier and said inputted keyword information is selected or generated.
